(19) United States
(12) Patent Application Publication
(10) Pub. No.: US 2007/0211705 A1
(43) Pub. Date: Sep. 13, 2007

(54) SERVER-LESS TELEPHONE SYSTEM AND METHODS OF OPERATION

(76) Inventor: Martin Thomas Sunstrum, Calgary (CA)

Correspondence Address: ST. ONGE STEWARD JOHNSTON & REENS, LLC, 986 BEDFORD STREET, STAMFORD, CT, 06905-5619, US

(21) Appl. No.: 11/621,012

(22) Filed: Jan. 8, 2007

Related U.S. Application Data
(60) Provisional application No. 60/766,283, filed on Jan. 8, 2006.

(51) Int. Cl. H04L 12/66

(52) U.S. Cl. 370/356

(57) ABSTRACT

Systems and methods are described for a plurality of telephony devices that have no central telephony call processing services (server-less) to discover each other in a peer-to-peer manner. The methods describe how telephony devices can discover and operate as a fully functional telephone system, not only on a local area network, but also across wide area network. This ability allows the deployment of a server-less telephone phone system across a large geographical area. The methods described also allow the telephone system to be logically segmented on a network, such that they don't interfere, or unintentionally share telephony resources with an unrelated deployment of a like server-less telephone system. Further still, the method also allows the packet network telephony devices to operate cooperatively with centralized telephony call processing services. By the nature of the peer-to-peer server-less methods, the devices can continue to provide telephony call processing services on the local network domain, in the event the centralized telephony call processing services becomes unavailable.

### FIELD OF INVENTION

Systems and methods are described for a plurality of telephony devices that have no central telephony call processing services (server-less) to discover each other in a peer-to-peer manner. The methods describe how telephony devices can discover and operate as a fully functional telephone system, not only on a local area network, but also across wide area network. This ability allows the deployment of a server-less telephone phone system across a large geographical area. The methods described also allow the telephone system to be logically segmented on a network, such that they don't interfere, or unintentionally share telephony resources with an unrelated deployment of a like server-less telephone system. Further still, the method also allows the packet network telephony devices to operate cooperatively with centralized telephony call processing services. By the nature of the peer-to-peer server-less methods, the devices can continue to provide telephony call processing services on the local network domain, in the event a centralized telephony call processing services becomes unavailable.

### BACKGROUND OF THE INVENTION

The nature of many businesses today is that they are becoming more and more geographically distributed, as business globalization takes effect. However, one problem for many businesses is that such enterprises may not have access to sophisticated IT resources, thus making it complicated and expensive to deploy sophisticated wide-area network telephony systems in a multi-site configuration spanning multiple network domains.

Generally, the present choices are for an enterprise to i) purchase and deploy a central call-control server phone system (referred to as an IP-PBX) that can provide advanced call control functionality and co-ordinate delivery of telephone system call functionality across multiple packet network domains or ii) subscribe to a hosted telephony service that supports advanced call control functionality expected for various business environments. For an enterprise, hosted service is effectively renting an IP-PBX server that is owned and maintained by some other entity. Both solutions are complex, costly, and an impediment to an enterprise or business looking to simply, rapidly and economically deploy a multi-site phone system.

Applicant's co-pending U.S. application Ser. No. 10/917,814 filed Aug. 13, 2004 (US publication 20050074031) and incorporated herein by reference describes a server-less phone system that allows phones within a localized network to self-configure. This system requires minimal end-user configuration if the phone system is installed on a local network domain whereby all packet telephony devices reside on the same local network domain. However, as it is known many networks are segmented into different network domains through the use of packet network elements such as NATs, firewalls, routers, VPNs, etc. that can separate the packet telephony devices described in Applicant's previous system (termed herein as “remote network domains”).

As a result, there continues to be a need to enable such server-less phone systems to be extended across multiple packet-network domains (multi-site), with minimal end-user configuration required in order to further address the problems of complexity and cost for businesses looking to deploy an advanced multi-site telephone system.

In addition, there is the problem of ensuring that packet network telephony devices can logically segment themselves from other like-packet network telephony devices that do not belong to their department and/or organization, and specifically, from a network security perspective, to ensure that one logical grouping of packet network telephony devices does not share data and resources with an unrelated grouping of packet network telephony devices. While other market systems and solutions allow a telephony device to detect what other logically partitioned systems have been detected, and join the one to their liking, such systems present a high security risk for a user to make unauthorized use of the telephony resources.

In addition, a problem faced by traditional centralized packet telephony phone systems, such as provided by an IP-PBX or hosted telephony service, is that remote sites lose their telephony service completely if packet network communication is lost between the remote site(s) and the centralized packet telephony phone system. Some solve this issue by deploying redundant and/or backup call control servers at the remote site. However, this greatly increases the complexity and cost of the solution.

As described in U.S. Patent application 60/766,283, (US publication 20060077955) entitled “System and Methods for a Survivable Remote Network”, a system is described that can detect if communication is lost between a remote site and a centralized packet telephony phone system, and that enables the remote site packet network telephony devices to then switch between server and server-less (peer-to-peer) modes, when central communication is present and lost, respectively. While providing a solution for some situations, this can be problematic in a number of situations, For example, if the system erroneously detects loss of communication with the centralized phone system server, all of the remote site telephony devices switch modes, potentially causing the remote site to inconveniently remain in server-less mode. This is a serious issue and would prevent the remote site from initiating and receiving any calls to/from the centralized phone system server, potentially indefinitely. This erroneous detection could be caused by a local network fault, unrelated to communication to the central phone system server.

In addition, for network security reasons, some network connections in an office may block external network traffic. (e.g. in a visitor room, boardroom). If the telephony device responsible for detecting communication to the central phone system server was in this situation, this could cause the remote site to remain in its server-less mode, and never get back to a central server controlled mode.

U.S. application Ser. No. 10/986297 (US publication 20050117525) entitled “Peer Discovery” also describes a server-less VoIP phone system.

### SUMMARY OF THE INVENTION

In accordance with the invention, a server-less voice over IP (VoIP) phone system and methods of operation are described that can allow telephony devices to discover and share information amongst themselves not only on the local network domain, but also to other network devices located in other remote network domains. This greatly simplifies end-user administration, and greatly simplifies the deployment of a business-quality multi-site phone system as compared to prior art systems.

In a first aspect of the invention, systems and methods are described of how local peers share information amongst themselves about remote peers they have discovered. Segmented network domains prevent the local peers from discovering remote peers without information regarding a remote peer being administratively entered into a local peer. This aspect of the invention allows an administrative entry to automatically propagate to other local and known remote peers, thereby minimizing the administrative entry to only one local peer, rather than all local peers. This is accomplished by a peer, who has initiated communication with a remote peer, notifying all discovered peers of this remote peer's network address.

In a second aspect of the invention, systems and methods are described enabling peers to logically partition themselves from other local and remote peers that are not intended to be part of the user's phone system. This is important, because in the local and remote discovery process, the ability is there to detect other like-packet telephony devices that belong to another organization. For security purposes it is important that information and resources are not shared with these other devices. In accordance with the invention, this is accomplished by using a shared workgroup name administratively entered into each peer. When one peer attempts to initiate data communication with another peer, this workgroup name is used as part of an authentication seed, and prevents logically partitioned peers from exchanging data between each other, and access to their telephony resources.

In a third aspect of the invention, systems and methods are described enabling local peers to have their telephony call processing services controlled by a centralized telephony call processing server, but continue to provide telephony call processing services amongst local peers if the one of the local peers detects that the centralized telephony call processing server is unavailable. In accordance with the invention this is accomplished by each telephony device operating in a server-less mode, and if so configured, simultaneously working in a centrally-controlled server mode also. Unlike the prior art, this system doesn't switch between a server and server-less mode. That is, each device operates in a “dual” mode and independently assesses its ability to communicate to the centrally controlled server.

More specifically, systems are methods are described wherein by discovering and sharing data continuously amongst all of peers, the end effect is that peers discover and store 2 network addresses, the local address of its peer, and the central server address of its peer. When it is detected that a central server is down, and initiation of telephony services to a local peer is required, the system can make use of the local peer address. Importantly, the system doesn't undergo a “switch” between 2 modes of operation but rather is effectively running in two modes at once, central-controlled and peer-to-peer (P2P). Other local peers may still be running in “centralized” mode, even though one local peer may have reverted to P2P calling.

More specifically, the invention provides a method for a first telephony network device to discover and communicate with a second telephony network device across a wide area network for establishing an operative communication link between the first and second telephony network devices and between at least one local peer of either the first or second telephony network device comprising the steps of:
a) the first telephony network device sending out a unicast discovery message to a predetermined device network address associated with the second telephony network device;
b) the second telephony network device receiving and responding to the unicast discovery message with a discovery response message;
c) the first and second telephony network devices establishing an operative communication link between each other; and
d) wherein upon establishment of an operative communication link between the first and second telephony network devices, either or both of the first and second telephony network devices enabling operative wide area and local area communication between the first and second telephony network devices and the at least one local peer.

In further embodiments, each of the first and second telephony network devices each have both a local area network address and a wide area network address and wherein both the local area and wide area network addresses are simultaneously allowed to enable operative communication between local area peers utilizing either of the local area or wide area network addresses.

In another embodiment, the local area network includes a plurality of local peers and wherein the local peers self-organize upon addition of each successive local peer to the local area network.

In a further embodiment steps a) and b) are periodically repeated to monitor dynamic changes in the network.

In a further embodiment, the first telephony network device discovers peer network devices on a local area network comprising the steps of:
a) the first telephony network device sending out a broadcast discovery message;
b) at least one peer network device receiving and responding to the broadcast discovery message with a discovery response message;
c) the first telephony network device and at least one peer network device establishing an operative communication link between each other; and
d) wherein upon establishment of an operative communication link between the first telephony network device and at least one peer network device, enabling operative wide area and local area communication between the first and second telephony network devices and the at least one local peer.

In another embodiment, the second telephony network device is a mobile telephony device and the wide area network includes an operative proxy service to enable movement of the mobile telephony device to an alternate local area network segment without administrative update.

In a further embodiment operative communication between the first and second telephony network devices is enabled if both the first and second telephony network devices are within the same defined workgroup.

In yet a further embodiment, the method further comprises the step of establishing a telephone call between the first and second telephony network devices using any one of a local area device network address or a wide area device network address.

In a further embodiment, the method further comprises the steps of initializing the first telephony network device with voice mail information; sharing the first telephony network device voice mail information with the second telephony network device; retrieving similar voice mail information from the second telephony network at the at least one peer; and enabling local area network and wide area network voice mail functionality.

In another embodiment, the invention provides a method for a first telephony network device to discover and communicate with other peer network devices across a local area network for establishing an operative communication link between the first telephony network device and at least one peer network device within a defined workgroup comprising the steps of:
a) the first telephony network device sending out a broadcast message to a local area network to identify all peer network devices on the local area network; and,
b) automatically establishing an operative communication link with all identified peer network devices on the local area network within the defined workgroup.

In another embodiment, upon establishment of an operative communication link between all identified telephony network devices on the local area network within the defined workgroup, automatically enabling operative wide area and local area communication between all telephony network devices across a wide area network within the defined workgroup.

In another embodiment, the defined workgroup is a hash of a defined workgroup name and wherein an operative communication link between the first telephony network device and at least one peer network device is established only if both the first telephony network device and at least one peer network device have the same hash.

In a further embodiment, the workgroup name is manually entered into each of the first telephony network device at the other peer network devices.

In yet a still further embodiment, a telephony network device is authorized to establish operative communication links within two or more defined workgroups.

In another embodiment, the invention provides a method for at least two local telephony network devices defined as local peers to communicate with each other across both a wide area network and a local area network comprising the steps of:
a) simultaneously enabling a local area network address and a wide area network address on each of the local telephony network devices; and,
b) enabling operative communication between local area peers utilizing either of the local area or wide area network addresses.

In one embodiment the method includes, following a failure of the wide area network while operative communication of two local area peers utilizing their respective wide area network addresses is enabled, automatically switching to use of local area network addresses to maintain operative communication between the local area peers.

In one embodiment, the wide area network includes a proxy server and wherein failure of the proxy server during operative communication of two local area peers utilizing their respective wide area network addresses, automatically switching to use of local area network addresses to maintain operative communication between the local area peers.

In yet another embodiment, the invention provides a network device enabled to discover and communicate with a second network device across a wide area network for establishing an operative communication link between the network device and the second network device and between at least one local peer of the network device comprising:
a) a microprocessor operatively connected to a wide area network communication interface, the microprocessor for a) sending out a unicast discovery message to a predetermined device network address associated with the second network device; b) receiving and responding to a discovery response message from the second network device; c) establishing an operative communication link between the network device and the second network device; and d) whereupon establishment of an operative communication link between the network device and second network device, enabling operative wide area and local area communication between the each of the network device, the second network device and the at least one local peer.

In a further embodiment, the network device includes memory operatively connected to the microprocessor for maintaining a table of data having data fields relating to the establishment and maintenance of the communication link and the second network device.

In another aspect, the invention provides a system comprising:
a) at least two local network devices within a local area network;
b) at least one remote network device outside the local area network but operatively linked to the local area network,
c) wherein each local network device is enabled to allow the local and remote devices to discover and communicate within the local area and wide area networks, each local network device comprising
   i. a microprocessor operatively connected to a wide area network communication interface, the microprocessor for a) sending out a unicast discovery message to a predetermined device network address associated with at least one remote network device; b) receiving and responding to a discovery response message from the at least one remote network device; c) establishing an operative communication link between the local area network device and the at least one remote network device; and d) whereupon establishment of an operative communication link between the local area network device and at least one remote network device, enabling operative wide area and local area communication between the each of the local area network devices and the at least one remote network device.

In yet another embodiment, the local network devices and at least one remote network device are selected from any operative combination of a centralized voice messaging device, an auto-attendant, unified voice mail server, music-on-hold device, overhead paging device, door opener or door phone.

### BRIEF DESCRIPTION OF THE DRAWINGS

The invention is described with reference to the drawings in which:

FIG. 1 is a block diagram of an illustrative telephone system 100;

FIG. 2 is a functional-level block diagram of an illustrative telephone set 200 device;

FIG. 3 is a block diagram of an illustrative telephone system 700;

FIG. 4 is a functional-level block diagram of a Voice Messaging 500 device;

FIG. 5 is a functional-level block diagram of a Multi-Port FXO Port 800 device;

FIG. 6 is a functional-level block diagram of a Ti/El Access 400 device;

FIG. 7 is a functional-level block diagram of Multi-Handset Cordless 600 devices;

FIG. 8 is an illustrative method of System Discovery sequences; and,

FIG. 9 is a representation of a data table built up from local and remote system discovery processes.

### DETAILED DESCRIPTION

With reference to the Figures a telephone system is described, the system including a plurality of telephony devices (preferably a packet telephony device), whereby there is no centralized call functionality controlling the operation of the telephone system. Each telephony device has embedded intelligence enabling each telephony device to discover other like telephony devices on a network and to self-organize into a fully functional and advanced telephone system. Generally, telephony devices that reside on the same local network domain are referred to herein as local peers, and those telephony devices that reside on remote network domains are referred to herein as remote peers.

In addition, a multi-site telephone system is described that can bridge across multiple network domains via an enterprise's existing VPN network, or that can be bridged by simple SIP proxy servers that are present in the network. The SIP proxy servers may be already deployed by the enterprise, or could be publicly available SIP proxy servers. The public SIP proxy servers may be free, or useable for a nominal cost. In many cases, they can provide value-added network telephony services for a small fee, or pay-as-you go approach. In any event, the enterprise is not required to deploy and maintain these SIP proxy servers. With respect to these SIP proxy servers, they are not required to provide any advanced centralized call processing services, as is common with IP-PBX devices, and hosted telephony services. Thus, the subject system enables advanced call processing services to be deployed/overlaid upon a “dumb” VPN or SIP proxy server network that has no inherent knowledge, or special configuration to support advanced call processing features as such advanced call processing features are coordinated by the packet telephony devices themselves such that the VPN or SIP proxy network provides simple device registration and/or message routing capabilities.

General Overview

With reference to the figures a Server-less VoIP telephone system is described.

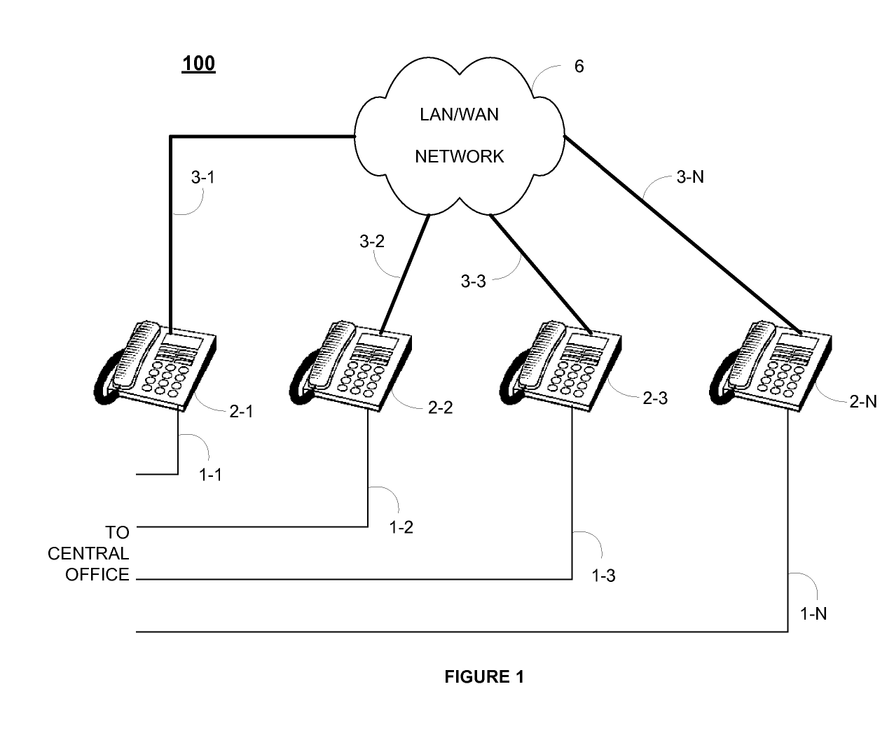

As shown in FIG. 1, a VoIP telephone system 100 is comprised of one or more telephone sets 2-1 through to 2-N. Each VoIP telephone set can optionally contain an FXO PSTN circuit and optionally be connected to a unique Analog Telephone Line 1-1 through to 1-N. The analog telephone line is a loop-start wire pair representative of facilities provided by a local central office or PBX (not shown), and is known in the art.

Each telephone set 2-1 through to 2-N is connected to a LAN/WAN Network 6 via LAN connections 3-1 through to 3-N. For the purposes of this description, each LAN connection is assumed to be a commodity 10/100 Mbps IEEE 802.3 Ethernet LAN cable connection. However, the LAN connection can also be made other ways, such as by Bluetooth™, 802.11 or other wireless means or routing IP traffic over other connections such as Firewire™ or USB™. In addition, the style of mechanical LAN connector may be any connector as known to those skilled in the art.

The LAN/WAN network 6 operates using industry-standard TCP/IP networking protocols. The LAN/WAN Network 6 consists of local area network(s) (LAN) and/or wide area network(s) (WAN).

This LAN/WAN Network 6 can be comprised of any of one or more of the following, including: local Ethernet switches, hubs, routers, firewalls, network address translators (NAT), intranets, public Internet, private TCP/IP WAN networks, or any other related network devices and implementations.

The purpose of the LAN/WAN Network 6 is to provide a local and/or wide area switching network for transport of digitized voice and control data to/from the telephone set, in addition to providing a communication medium for other common industry TCP/IP devices (PCs, printers, servers, Internet, other devices and networks). These TCP/IP network elements, and the mechanisms behind their operation, are known and will not be described further.

With these elements, a full-featured telephone system is created. The telephone system 100 supports all common calling modes found in a conventional phone system, such as external PSTN calls, internal business intercom calls, call transfer, call forwarding, call paging, and call parkup/pickup functions. Unlike the prior art, the phone system can also handle voice-over-Internet-protocol (VoIP) calls internal to a LAN environment and across a wide area network (WAN).

Telephone system 100 can also provide desirable voice messaging features such as auto-attendant and voicemail functionality. In addition, telephone system 100 can provide a method for advanced voice messaging features, whereby voice mail messages, call recordings, and/or voice recordings messages are handled by the telephone set alone, and can be delivered to end users or services via common TCP/IP delivery techniques such as e-mail.

The methods behind the delivery of these features will be described later in this description.

Telephone Set Description

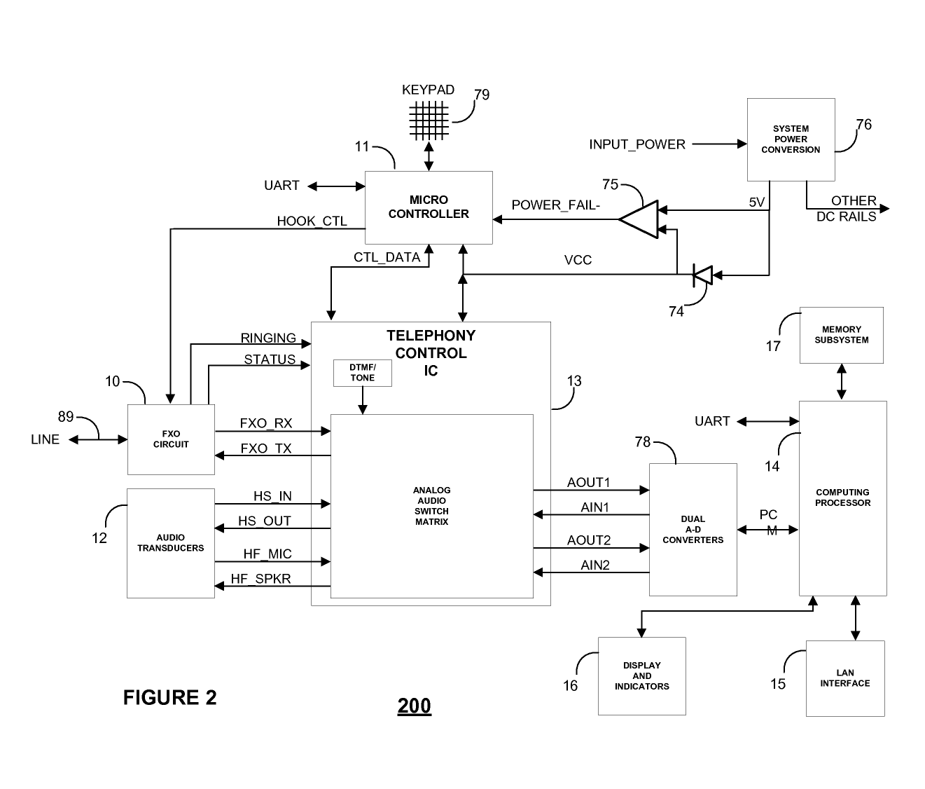

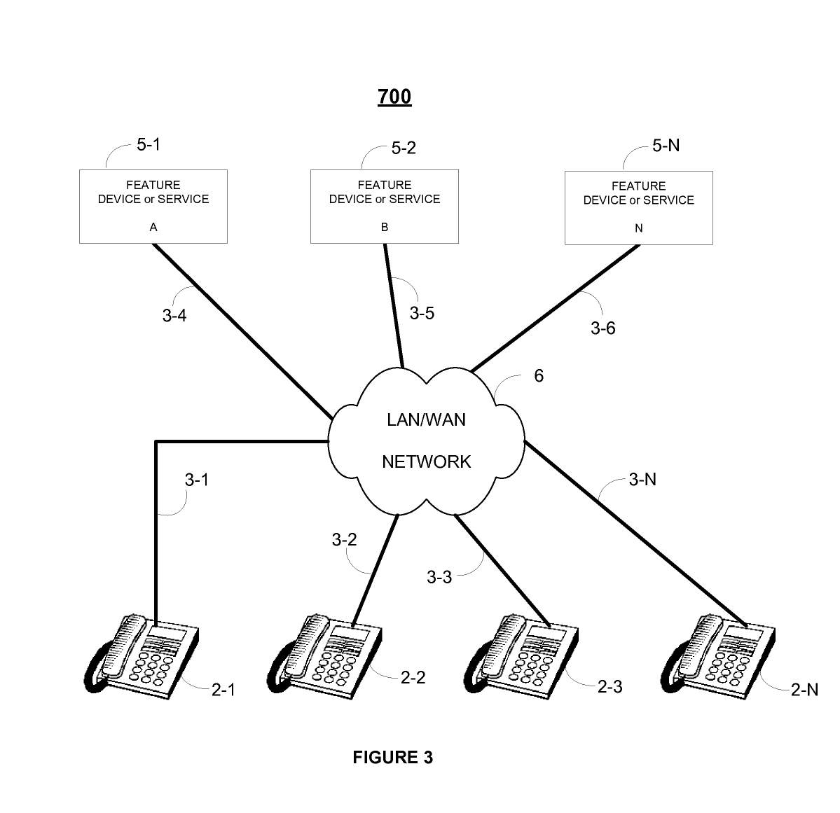

For the purposes of this description, each telephone set 2-1 through to 2-N is assumed to be identical in terms of design, and as such, only one illustrative telephone set, telephone set 200 will be described. An illustrative functional block diagram of a portion of telephone set 200 is shown in FIG. 2.

FXO Circuit 10

This optional circuit provides FXO circuit functionality including on and off hook switch control and a 2 to 4 wire hybrid audio circuit interfacing the 2 wire telephone line 89 loop start signal pair to the (4 wire) transmit and receive audio signals FXO_TX and FXO_RX respectively. A STATUS signal provides status information such as FXO line voltage and/or current indications. Analog audio signals FXO_RX and FXO_TX and STATUS, and the ringing voltage signal (RINGING) signal is connected to the Telephone Control IC 13. The FXO Circuit 10 also provides the telephone set 200 ground signal reference. The ground signal reference is accomplished with a common diode bridge following the 2 wire telephone line 89 TIP and RING leads. Ground is effectively referenced to the most negative voltage of the telephone line.

Audio Transducers 12

Audio transducers represent the common handset audio and speakerphone transducers. For the handset, the analog audio signals are HS_IN and HS_OUT. For the speakerphone transducers, the analog audio signals are HF_MIC and HF_SPKR.

Telephony Control IC 13

The telephony control IC is an integrated circuit (IC) that provides a non-blocking analog audio switch matrix between the following analog audio inputs: FXO_RX, HS_IN, HF_MIC, AIN1, AIN2 and DTMF/TONE (internal) and the following analog audio outputs:
FXO_TX, HS_OUT
HF_SPKR, AOUT1
AOUT2.

The internal audio generator DTMF/TONE is able to generate DTMF and simple tone audio signals.

A key feature of the Telephony Control IC 13 is that it can generate power, hereinafter referred to as “VCC” power, when the main 5V power is not present. This VCC power is derived from the FXO line current when off-hook, or from the FXO ringing signal when onhook. Only the Telephony Control IC 13, the Microcontroller 11, the FXO Circuit 10 and the Audio Transducers 12 are powered with VCC. The Telephony Control IC 13 is controlled, and can provide status information to the Microcontroller 11 via the CTL_DATA signals.

5V Power Blocking Diode 74

The 5V power blocking diode 74 provides isolation between the 5V and VCC DC power signals. As mentioned in describing the Telephony Control IC 13, if the 5V DC power signal is not present, this diode will prevent any VCC DC power generated by the Telephony Control IC 13 from feeding into the 5V power rail. It is, of course, understood that other voltages may be used.

5V Power Comparator 75

The 5V power comparator 75 is a simple voltage comparator circuit that compares the VCC and 5V voltage levels. If the 5V signal is present, a logic 1 POWERFAIL signal is presented to the Microcontroller 11, otherwise a logic 0 POWERFAIL-signal is presented. To prevent electrical latchup of the VCC powered devices from the other nonpowered devices in the apparatus, the Microcontroller 11 uses this signal to know when to electrically isolate the UART signal. The AOUT1 and AOUT2 signals are capacitive-coupled to the Dual A-D Converters 78, so they already would have DC isolation between the VCC powered Telephone Control IC 13 and the non-VCC powered Dual A-D Converters 78.

Microcontroller 11

The Microcontroller 11 is powered via the VCC DC power signal, which is derived via the main 5V power rail, or in the absence of such, via VCC generated by the Telephony Control IC 13. This microcontroller requires a low operating current (typically<8 mA) as the Telephony Control IC 13 is limited in how much power (current) it can deliver to VCC when the main 5V power rail is absent. Via the CTL and HOOK_CTL signals, the Microcontroller 11 can control the operation of the FXO Circuit 10 and the Telephony Control IC 13. The Microcontroller 11 has a standard 2-wire UART connection to the Computing Processor 14, whose purpose is to communicate messages between each other. The Microcontroller 11 also performs key press detection on the keypad scanning matrix 79.

The control firmware resident in microcontroller 11 operates in 2 modes. When it detects lack of 5V power via the 5V Power Comparator 75, the Microcontroller 11 operates in Autonomous mode. In Autonomous mode, the Microcontroller 11 fully controls the FXO Circuit 10 and the Telephony Control IC 13. This allows the telephone set 200 to operate similar to a plain analog POTS telephone.

When the microcontroller 11 detects the presence of 5V power via the 5V power comparator 75, the microcontroller 11 operates in slave mode. In slave mode, the microcontroller 11 reports status information (key presses, ringing signals, etc.) using UART messages to the computing processor 14. The FXO Circuit 10 and the telephony control IC 13 are only controlled by the microcontroller 11 upon reception of the appropriate UART message(s) from the computing processor 14. The design of the microcontroller firmware supporting autonomous and slave modes is familiar to one skilled in the art.

Thus, a telephone set 200 can operate without the main 5V power rail, and act as a regular POTS line-powered telephone. In addition, the telephone system 100 can provide power fail operation to each of the unique analog telephone line 1 -1 through to 1-N connected to telephone sets 2-1 through to 2-N.

For the purpose of this description, it is assumed that the telephone set 200 is operating under normal 5V powered conditions.

Keypad Scanning Matrix 79

This keypad scanning matrix is a standard row/column keypad scan matrix operated by the Microcontroller 11 to detect when keys are pressed and released.

System Power Conversion 76

The System Power Conversion 76 provides various DC voltage rails as needed by the telephone set 200. For the purposes of this description, 5V is a required voltage rail. Other DC rails are provided as needed by any specific design. The INPUT POWER is any AC or DC input power signal that is appropriate for the design. Power can be delivered via a wall power cube, or delivered through wires on the LAN cable (e.g. as defined by IEEE 802.3af standard).

In the design described herein the telephone set 200 ground signal is referenced to the telephone line, INPUT POWER that must have appropriate safety/regulatory voltage isolation from the telephone line. Alternatively, alternative electrical designs may be used whereby, for example, the FXO Circuit 10 provides the necessary safety/regulatory voltage isolation, and yet still provide power fail operation.

Dual A-D Converters 78

Dual A-D converters 78 provide 2 channels of analog-digital and digital-analog conversion paths to the analog audio signals AIN1, AIN2, AOUT1, AOUT2 emanating from the Telephony Control IC 13. The digitized signals are transported to/from the computing processor 14 via a multiplexed digital data stream, such as a PCM stream bus.

Computing Processor 14

The computing processor 14 represents the digital control processor unit for execution of the main apparatus application firmware. It can consist of appropriate microprocessor and/or DSP processing devices as is required. The Computing Processor 14 runs the application software resident in the memory subsystem 17. When 5V (or as otherwise appropriate) power from the main power rail is present, the computing processor 14 controls the whole operation of the telephone set 200.

The computing processor 20 requires sufficient computing power and appropriate software algorithms to process these audio signals. These capabilities include:
a) Flexible audio frequency band tone (and multi-tone) generation and detection capabilities used for such functions as DTMF tone detection and generation, caller-id (and call-waiting id) FSK signal detection, and various other common telephony tone signalling activities.
b) When audio to/from the FXO and/or speakerphone transducers is transported across the LAN interface 15, algorithms are required to perform appropriate line and/or acoustic echo cancellation within telephone set 200. The design parameters around these echo cancellers are well known, and their performance criteria is well described in the International Telecommunications Union (ITU) G.168 standard.
c) Ability to handle multiple independent instances of playing and recording audio data from/to the Memory Subsystem 17.
d) Flexible audio gain control is required for all audio paths. This would include audio muting and automatic gain control circuits as needed.
e) Flexible audio mixing, and if desired, audio conferencing control of various audio output and input paths. The audio mixing capabilities facilitate call recording and call monitoring capabilities. The mixing/conferencing with audio paths to/from the Telephony Control IC 13 analog audio switch matrix, and one or more call sources to/from the LAN network.
   Memory Subsystem 17

The memory subsystem 17 provides all of the volatile and non-volatile memory storage for the application software, data and algorithms, as required for any devices as part of the computing processor 14. Examples of this memory storage are flash memory, SDRAM memory,and EEROM. The application software and algorithms contain all the functions to perform the necessary TCP/IP and VoIP protocol stacks such as TCP, UDP, RTP, SIP, SMTP, HTTP, FTP, and TFTP.

LAN Interface 15

The LAN interface 15 provides the Ethernet 802.3 interface, which includes the media access controller (MAC) and physical interface (PHY).

Display and Indicators 16

The LAN Interface 15 may include common telephone items such as indicator LEDs, LCD display, and/or buttons.

Telephone Set 200 Suggested Off-the-Shelf Integrated Circuits

The telephone set 200 can be built by using “off-the-shelf” integrated circuits such as:
a) Broadcom™ BCM1101 VoIP Processor. This IC effectively provides the functionality of the Computing Processor 14, Dual A-D Converters 78 and LAN Interface 15.
b) Atmel™ U3900BM Telephony Processor. This IC effectively provides functionality of the FXO Circuit 10 and Telephone Control IC 13.
c) Atmel™ AT90S8515 AVR Microcontroller. This IC effectively provides functionality of the Microcontroller 11 and 5V Power Comparator 75.

Manufacturer datasheets and application notes relating to the above integrated circuits give an abundance of information of technical information as to the operation and recommended design considerations.

VoIP Protocols Operational Description

Within this patent description, VoIP protocol functionalities of the telephone system 100 and telephone set 200 are described with respect to the SIP and RTP protocols. For example, it is known that digitized audio data is transported across the LAN Interface via the RTP protocol, and call setup and control information is transported across the LAN Interface 15 via the SIP protocol. The IETF reference document that explains the SIP and RTP protocols can be found in RFC 3261 and RFC 3550 respectively.

The following is an illustrative example, with regards to VoIP protocol operation of the telephone set 200.

When the incoming PSTN call arrives at the telephone line, it generates a ringing signal. Via the FXO circuit 10 and the telephony control IC 12, the microcontroller 11 is notified that the line is ringing, and if available, would be notified of any caller identification information. The microcontroller 11 relays this status information to the Computing Processor 14 via a UART message.

The Computing Processor 14 can now initiate a SIP call to one or more other telephone set 200 devices (including itself) on the LAN/WAN Network 6 by sending out the appropriate SIP INVITE messages to the other telephone set 200 devices. If the Computing Processor 14 receives a SIP OK message from a telephone set 200 via the LAN/WAN network 6, it can proceed to set up the call by sending message(s) to the microcontroller 11 to take the FXO Circuit 10 to an off-hook state, and to route the FXO_RX and FXO_TX audio signals through the Telephony Control IC switch matrix to the AIN1 and AOUT1 audio paths.

This connected audio can pass through one channel of the Dual A-D Converters 86 and the digitized audio is transported via the LAN Interface 15 via the RTP protocol to the other telephone set 200 on the LAN/WAN Network 6. Now a complete call path is in session between the FXO Circuit 10, and another telephone set 200 on the LAN/WAN Network 6.

At the same time, an appropriate SIP INVITE message can be received at the same telephone set 200 via the LAN Interface 15. The Computing Processor 14 can send a message via the UART to Microcontroller 11 to alert the human user of telephone set 200 via an audible alerting signal that an incoming call from another telephone set 200 is available. The Microcontroller 11 can detect when the user picks up the handset (or activates a speakerphone key press), and send this status information via the UART to the computing processor 14. The Computing Processor 14 can now send a SIP OK message to the calling telephone set 200 on the LAN/WAN Network 6.

The computing processor 14 proceeds to send message(s) to the microcontroller 11 to route the appropriate audio transducers 12 audio signals through the telephony control IC switch matrix to the AIN2 and AOUT2 audio paths. This connected audio can pass through the second channel of the dual A-D converters 86 and the digitized audio is transported via the LAN Interface 15 via the RTP protocol to the other telephone set 200 on the LAN/WAN Network 6. Now a complete call path is in session between the human user, and another telephone set 200 on the LAN/WAN Network 6.

It is important to note that the call from the FXO Circuit 10, and the call answered by the human user are independent of each other. That is, the telephone set 200 can simultaneously perform an independent SIP call session on the FXO Circuit 10, and another independent SIP call session using the Audio Transducers 12. This is not the case with the prior art of VoIP phones that contained a FXO port.

To one skilled in the art, it is apparent how outgoing and incoming FXO calls can occur, or how a human user could also initiate and receive a call, and how these calls would be terminated. It is also possible for the incoming FXO call to have been answered by a human user on the same telephone set 200 device.

Server-Less VoIP Telephone System Operation

In a preferred embodiment within the VoIP telephone system 100, each telephone set 200 communicates, via its LAN Interface 15, to other devices using peer-to-peer TCP/IP communication protocols. Each LAN connection 3-1 through 3-N for each telephone set 200 device could be on different LAN or WAN segments, different TCP/IP networking equipment, and finally, located across both small and large geographical distances. Unlike the prior art using the RF communication method, this communication path is not along a common, shared RF communication path, but rather across distributed and network addressable path, the LAN/WAN Network 6.

This has the major advantage over prior art RF communication methods, for it overcomes the aforementioned disadvantages of RF channel capacity, line REN limits, and shared telephone line cable lengths and terminations. In addition, when a power fail situation occurs, each telephone set 200 device can provide basic ability to make and receive phone calls on any unique analog loop-start lines routed to the FXO port of such telephone set 200. This is unlike prior art where power fail operation was limited to only the one shared loop-start line, or relied on the usage of additional regular POTS phones connected on the analog loop-start lines. This provides numerous end user safety and convenience advantages for a business experiencing a power fail or LAN outage.

Another key advantage is that telephone set 200 devices could be deployed across a potentially very large geographical distance via the LAN/WAN Network 6, limited only by the capability of the WAN. For example an office could have several telephone set 200 devices on their customer premises, and other telephone set 200 devices located in different towns, cities and even countries. This is a capability not found in the prior art.

In accordance with the principles of the invention, the elements shown in FIG. 1, i.e., telephone sets 2-1 to 2-N communicate to each other over the LAN/WAN Network 6 in a peer-to-peer manner. In other words, there is no centralized server coordinating the actions of each telephone set. Each telephone set 200 comprises its own system and call processing software.

As described further below, telephone system 100 is self-configurable. The system accomplishes this by allowing each telephone set 200 to supply specific information and capabilities about themselves to other telephone set 200 devices upon request.

In addition, each telephone set 200 can subscribe to receive notifications of changes in resource status of other telephone set 200 devices in the system. As a result, telephone system 100 provides plug-and-play functionality. Examples of system resources are: intercom number, voice channels, FXO line capabilities, voice messaging services, etc.

Examples of changes in resource status include whether not a FXO port(s) is presently in use, whether a user is actively using a telephone set device, information on various intermediate states of a resource (e.g. ringing, on-hold, idle, do-not-disturb, and similar reports).

Upon initialization, each telephone set 200 goes through various discovery stages about the telephone system available on the LAN/WAN environment. The end result of these stages is that the system is capable of discovering other telephone set 200 devices, and gathers enough information from those devices to be able to self-organize into an operating VoIP telephone system. This includes auto-assignments of intercom extension numbers, knowledge of available external analog loop-start lines, availability of system voice messaging features. During this stage, it may prompt the user for further information depending on how successful it was in determining its external environment.

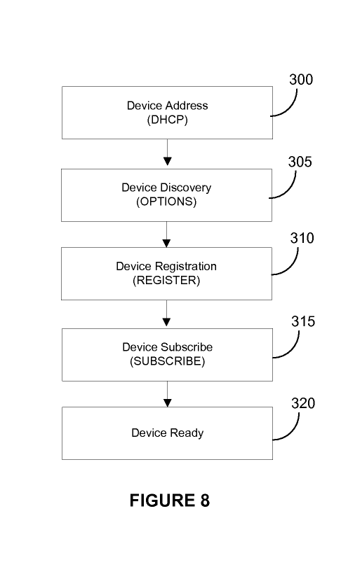

For illustrative purposes, FIG. 8 shows the various stages involved. Below describes one implementation of these discovery stages. Various alternative methodologies would be understood by those skilled in the art. For illustrative purposes only, description of these stages refers to commonly defined usage of the Internet and SIP protocols.

Alternative embodiments are certainly possible using different protocols or networking environments. The first stage 300 is called Device Address. The first action of the telephone set 200 is to determine an IP address for itself. By default the telephone set 200 uses DHCP to obtain a dynamically assigned IP address from a DHCP server on the LAN network. Alternatively, the telephone set could be configured a static IP address, as is common in for VoIP telephone sets, or in the situation where no DHCP server is present, auto-determine an IP address for itself using a non-DHCP IP assignment protocol such as zeroconf. All other basic telephone set initializations occurs during this stage.

The second stage 305 is called device discovery. Using common broadcast, unicast and/or multicast techniques familiar to one skilled in the art, the telephone set 200 attempts to determine whether or not it is in a different LAN network. If it is in a different LAN network environment from when it was last powered, or LAN cable was unplugged and reinserted, or if it is the first time the telephone set 200 has ever been initialized, the telephone set 200 will attempt to discover the basic presence of other like telephone set 200 devices on its local LAN environment.

For illustrative purposes, this discovery can occur by the initializing telephone set 200 sending out a broadcast SIP OPTIONS message to its local LAN segment. The purpose of this message is to allow other devices on the network to become aware that telephone set 200 is now present on the local network segment. telephone set 200 should send this message upon major events, such as upon power-up, upon a LAN cable being plugged into telephone set 200, and also periodically sent out at random time periods. A broadcast message is illustrated only because many small business establishments typically have low-end routers that may not support multicast, or require special network administration skills. It can also send unicast or multicast SIP OPTIONS messages to devices on the WAN. Recipients of the SIP OPTIONS message will send back a message indicating information and status and/or capabilities of the recipient device. This allows the telephone set 200 to, firstly, know what devices are on the network, and secondly, determine the capabilities of the responding telephone set 200 devices. The initializing telephone set 200 can then make a decision as whether or not this capability is of interest. As understood, other protocols may be used.

This stage is also important for any responding telephone set 200, for it is has now become aware that the initializing telephone set 200 is present on the network. For example, it is optional, but common for the for the SIP OPTIONS message to have a “User-Agent” field. This field could indicate that the originating device represents a telephone set 200, and possibly have extra specific information about the device. This optional “User-Agent” field can help the recipient know that the originator of the OPTIONS message is from a like device. This helps it differentiate an OPTIONS message that may have originated from an incompatible 3rd party device or SIP service. This knowledge can be optionally used in determining if the recipient will further communicate to this originating telephone set 200. The fields of the OPTIONS message, notably the “From” field, indicates to the recipient the network address URI of the originator, as described in the SIP RFC3261 specification. The form of this address could be a direct IP address notation (e.g. 123@192.168.0.44), or in the form of a network DNS-resolvable URI address (e.g. fred@thisnetwork.com). It is this network address URI that the recipient stores locally as a minimum amount of information to further communicate with the other device.

Pertinent information about this stage 305 is stored locally in non-volatile memory storage area on the telephone set 200.

If the telephone set 200 determines that it is in a different LAN network, then the telephone set 200 reconfirms and updates the system information that is stored in the telephone set 200 non-volatile memory storage area (data store). Any newly discovered telephone set 200 devices are added to the data store. Any devices no longer present on the system are typically removed from the data store. The user may optionally be prompted to confirm this action. In certain situations their information may be delayed in removal by an appropriate aging algorithm. This is to prevent inadvertent re-assignment of intercom numbers if another previously discovered telephone set 200 device is off-line (not present) in the system for a short duration. This duration might typically be 15 days or less, or this duration could be determined by an administrative setting.

System information as described above is discovered automatically. This system information can be augmented by fixed information entered into the telephone set 200 via a local or remote administration service. This allows the phone system to accommodate devices that cannot be located by the System Discover stage, and to support third-party VoIP devices or services as known. They would include administration settings accessed with the telephone set keypad and LCD display, or by processing appropriate messages received on the LAN Interface 15, or by any other known programming interface. Presently, the method above only allows automatic discovery of devices on the same network segment (subnet) that is reachable by a broadcast (or multicast) OPTIONS message. Later on it is described how the discovery system can discover other devices that are located on different network segments. As a representative example, these different network segments can be bridged by Virtual Private Networks (VPN) or bridged by SIP registration/proxy servers as are known.

The next stage 310 is called Device Registration. In this stage, the telephone set 200 attempts to register itself to each of the other telephone set 200 devices in the system, using the SIP REGISTER method. The other telephone set 200 devices can either accept or reject this registration attempt. If a telephone set 200 rejects a registration attempt, this merely means telephone set 200 cannot take advantage of the resources or services of the rejecting telephone set 200. As is known, the purpose of REGISTER method is typically to register to a central registration server, a common component to a SIP proxy server. In the subject server-less VoIP phone system, obviously there is no SIP proxy server that must be used, hence it is optional that a telephone set 200 registers to another telephone set 200 device. The preferred method is that telephone set 200 simply proceeds to attempt to SUBSCRIBE to the other device as described below.

If it is of interest, the telephone set 200 has the option, now, or at a later time, to go to the stage 315, called Device Subscribe. Using the SIP SUBSCRIBE method, the telephone set 200 can subscribe to one or more asynchronous event notifications from other telephone set 200 devices available on the network. The subscribed telephone set 200 delivers these to the subscriber via the SIP NOTIFY method. Familiar to one skilled in the art, the SIP SUBSCRIBE method, as defined in IETF RFC 3265 can be challenged and authenticated by the recipient. This enhances system security such that non-system devices may be prevented from subscribing to the NOTIFY messages and their contents. In addition the NOTIFY message contents could be encrypted to not allow network monitoring elements from seeing the potentially sensitive content data in a NOTIFY message.

The NOTIFY method can also be used, in addition to status event notifications, to transfer configuration data between subscribed telephone set 200 devices. This is the preferred method to exchange specific data between telephone set 200 devices. The data exchanged can include information such as assigned phone system extension numbers, associated telephone set user name (e.g. Bob), FXO line name (e.g. Line 1), email address associated with user, call preferences, call forwarding settings, telephone set characteristics, an optional SIP network URI address(es) for the extensions and/or FXO port, and any other desired data that one wants to share. As is known, the data and event info are communicated in the Contents section of a NOTIFY message. Any change in configuration data on one telephone set 200 can be communicated to another telephone set 200 by usage of the NOTIFY message. Again, usage of the SIP protocol and its NOTIFY method is demonstrative on the concept, but this concept can apply to any other SIP messages or other protocol implementations.

The SUBSCRIBE and NOTIFY are important mechanisms to allow a telephone set 200 to receive notification from another telephone set 200 indicating pertinent status information such as FXO port being in use, if the set is in use by a human user, or do not disturb settings. This allows the telephone system 100 as a whole to deliver common expected features such as FXO line and set indicators. Again, this information is delivered to each telephone set 200 from an individual telephone set 200 and not coordinated by a central control server. The IETF reference document that explains these SIP SUBSCRIBE and NOTIFY methods can be found in RFC 3265.

Note that since all telephone set 200 devices perform the same discovery action, the end result is that any two telephone set 200 devices end up having separate SUBSCRIBE sessions between each other, and that each send to each other their respective NOTIFY messages containing status events and/or set-specific data.

Beyond stage 315, the telephone set 200 moves to stage 320, called the Device Ready state. Here the telephone set 200 is ready to operate and participate in the system. It is noted that other telephone set 200 devices may do the same stages 305, 310 and 315 against this telephone set 200, such that they can take advantage of the resources and capabilities of the newly initialized telephone set 200.

From the telephone set 200 perspective, it is now aware of other telephone set 200 devices on the network. It is also aware of the availability of FXO port(s), if any, on the network. To make use of these system resources, the telephone set 200 would make use of various SIP messages such as INVITE, OPTIONS, SUBSCRIBE and NOTIFY messages to know the status and/or current capabilities of the specific system resource, and request the usage of that system resource. Calls to/from the telephone set 200 can occur using known SIP INVITE methods. The telephone set 200 can handle independent SIP sessions for use of its FXO port(s), if available, and also for the use of the device transducers.

To stay aware of any dynamic changes in the network, and hence the phone system, the telephone set 200 periodically repeats Stage 305 to determine if there are changes in the telephone system 100. (i.e. telephone set 200 devices added, removed, changed). It is suggested that this Stage 305 is repeated at intervals of 2 minutes or less to be responsive to the changes.

Telephone set 200 can be made aware of another telephone set 200 disappearing from a network by making an innovative use of a expiry mechanism inherent in the SIP SUBSCRIBE method. Expiry mechanisms are described in IETF RFC 3515. When a SUBSCRIBE is established with another telephone set 200, the telephone set 200 devices can negotiate an “Expiry” timeout. Upon this timeout, the SUBSCRIBE must be renewed so that it can continue to receive status events and set data from the subscribed telephone set 200. If the second telephone set 200 is no longer present on the network, the renewal SUBSCRIBE will not succeed, and the originating telephone set 200 can use this as an indication that the other telephone set 200 is no longer present on the network. The SUBSCRIBE expiry timeout can be set appropriate to the removal detection resolution desired. This could be anywhere from one minute, to tens of minutes.

To summarize, a telephone set 200 becomes aware of the presence of another telephone set 200 on the network by receiving an OPTIONS message from another telephone set 200. It can be made aware of the removal of that same telephone set 200 by one of two methods. It could periodically send a unicast OPTIONS message back to the other telephone set 200 and see that there is no corresponding SIP response from that telephone set 200, as is known to one skilled in the art. A second, preferred method is that both telephone set 200 subscribe to each other with the SUBSCRIBE method. Upon expiry of that SUBSCRIBE, if the SUBSCRIBE renewal fails, then the telephone set 200 can assume that the other telephone set 200 is no longer available on the network. It could be no longer available because the telephone set 200 has been physically powered-down, removed from the network, or there is some other fault in the LAN/WAN Network 15 environment.

Once this each telephone set 200 establishes each other's presence as described above, they can each store the network URI address of the other telephone set 200. In the discovery, the network URI address allows them to reach each other. The full SIP network URI address can also be exchanged in the NOTIFY message exchanges. Thus, the system allows the innovative telephone system to self-organize. Without this mechanism, a user would have to manually enter in the network address of each peer telephone set 200. This is obviously a time-consuming and unattractive choice for end users setting up the phone system.

Allowing a telephone set 200 to know the network URI addresses of all other peer telephone sets 200 in the system allows the delivery of advanced telephony features such as call transfers, call park, call pickup, set paging, voicemail delivery between peers, etc. to be delivered in a peer to peer fashion without any centralized control.

Many IETF RFC documents describe these advanced telephony call control functions using the SIP protocol in a peer-to-peer fashion. However, they don't address how each peer SIP device determines the network URI address of the other peers SIP devices in the network. System Discovery as described herein provides a solution for automatically determining and exchanging network URI addresses in the peer-to-peer telephone system 100. Each peer telephone set 200 communicates that information to each other, without having to resort to getting that information from some centralized data store, or required an administrative entry to be entered for every network URI address into every telephone set 200.

It is also noted, that beyond the original broadcast (or multicast) OPTIONS message on the local LAN environment, all other messaging are unicast messages between respective telephone set 200 devices. This is the preferred method over multicast/broadcast messaging techniques, although it doesn't exclude using those messaging techniques. The reason unicast messages are the preferred method is because is because of wider interoperability in real world network environments. Both broadcast and multicast messages aren't appropriate methods when traversing the Internet and most Virtual Private Networks (VPN).

In the System Discovery, the subject system can discover all peer telephone sets 200 on a local LAN network segment reachable by a broadcast (or multicast) OPTIONS message. There are certain situations where an office may want to separate peer telephone sets 200 on the same local LAN network segment so that they do not discover each other.

Accordingly, an embodiment is described that allows separating peer telephone sets 200 into separate workgroup segments, even though the peer telephone sets 200 are one the same local LAN network segment, reachable by the broadcast (or multicast) OPTIONS message. By a manual administrative method, one can enter one or more workgroup names into each telephone sets 200. For example, a name such as “Office” or “XYZ Company”, or any user selected name such as “0fd3qzw812” could be entered. The system would include administration settings accessed with the telephone set keypad and LCD display, embedded web server pages on telephone sets 200 or by processing appropriate messages received on the LAN Interface 15, or by any other known programming interface.

To implement the workgroup network separation, during the Device Subscribe stage, the peer telephone sets 200 devices would use SUBSCRIBE authentication as described in IETF RFC3261 and IETF RFC3265. Telephone set 200 devices would use in whole, or part, or a recombination of the workgroup name as a shared secret authentication password response. As known, this SUBSCRIBE digest authentication process would hash (typically using a MD5 algorithm (or other), with a nonce seed) the workgroup name. This hash response is resent in another SUBSCRIBE attempt, and hence this would keep the workgroup name private, secure, and not visible by network monitoring tools. The hashed value would be created, as a minimum from some part, or the whole of the workgroup name, and a nonce value. It wouldn't include in the hash a username or URI entry, or any other input value that would cause the resulting hash value to not be identical no matter what peer telephone set 200 is attempting to subscribe, and belongs to the same workgroup.

This allows the telephone sets 200 to compare the hash value solely for the purpose of knowing if the subscriber belongs to the same workgroup. If the hashed value of the workgroup name did not match the recipient's hash of its own workgroup name, the recipient would reject the SUBSCRIBE authentication sequence with a 4xx SIP response as is known. If rejected, no NOTIFY messages would be exchanged, and hence telephone sets 200 would not obtain device status and/or configuration data of the other peer telephone sets 200. If a telephone set 200 belonged to more than one workgroup and it was rejected in its first attempt, it could retry to the same telephone sets 200 by attempting to SUBSCRIBE using an alternative workgroup name. As understood, other variations of exchanging and verifying that each peer telephone set 200 belongs to the same workgroup name(s) can be devised using variations of this method.

The workgroup network separation feature is important from a security point of view, for any new telephone set 200 added onto the local network would have to have the same workgroup name before it could participate in the system. Using normative security precautions, this workgroup name would be manually entered by an administrative method, and the workgroup name would be kept secret from casual users or outside parties.

All, or some portion of the workgroup name can be also used as an encryption key for the NOTIFY message contents. Or conversely, a separate shared key entry could be done in an administrative method and used. As mentioned previously, NOTIFY message contents should be encrypted to not allow network monitoring elements from seeing the potentially sensitive content data in a NOTIFY message.

As is known, the above described digest authentication process can be used to other SIP messages. Notably the SIP INVITE message challenge would be appropriate if one wanted to authenticate calls to the extension and/or FXO resources of a telephone set 200 device.

As described previously, the discovery process generally only works on a local LAN segment, and cannot discover telephone set 200 devices that are on different LAN segments. Herein, these non-local telephone set 200 are called a remote telephone set 200. These different LAN segments can be bridged by VPNs or SIP registration/proxy servers as known. In order to undertake a discovery process for remote telephone set 200 devices, a telephone set 200 must know the network URI address that addresses the specific remote telephone set 200.

The present System Discovery process is limited to finding peer telephone sets 200 devices on the same local LAN network segment that is reachable by a broadcast (or multicast) OPTIONS message. If a peer telephone sets 200 is on another network segments (remote peer), the network URI address of the remote telephone set 200 can be entered into the local telephone set 200 via a local or remote administration service, as is known. Since the remote telephone set 200 was not discovered locally, the local telephone set 200 will send a unicast OPTIONS message to the network URI address of the remote telephone set 200. Upon receipt of the OPTIONS message, the remote telephone set 200 will initiate a SUBSCRIBE/NOTIFY sequence as previously described with each other and both telephone set 200 devices will become aware of each other's presence and become operational. This sequence of events is essentially identical to the local System Discovery process previously described.

Both the local and remote telephone sets 200 are now aware of each other. In this scenario, the remote telephone set 200 is not at all aware of other sets that are known to the local telephone set 200 device on the local network segment domain, and vice versa. As such, one would merely need to simply repeat this process on other local telephone set 200 devices. However, for a system with many telephone sets 200, this is not desirable as for each remote telephone set 200, the remote network URI address would have to be manually entered into each local telephone set 200. This is a time consuming, error prone and tedious administrative effort.

Hence, an innovative enhancement to the System Discovery is described which allows discovery of remote telephone sets 200. The intent is that end users are just required to enter a network URI address of at least one (preferably one) remote telephone set 200 per remote network segment on one local telephone set 200. Following such an administrative entry, then all remote and local telephone sets 200 become aware of each other's presence without further user administrative intervention. In addition, a brand new or newly present telephone set 200 on the network will have its list of remote peer telephone sets 200 automatically updated. Especially in a larger system, this can save significant administrative effort.

The key behind Remote System Discovery is the previously described local System Discovery mechanisms. All the peer telephone sets 200 on each local LAN network segment have the ability to communicate to each other directly via the SUBSCRIBE/NOTIFY mechanism. In addition, the local System Discovery mechanism allows a telephone set 200 to detect the new presence or removal of a peer telephone set 200.

When a network URI address of at least one remote telephone set 200 is administratively entered into a local telephone set 200, it will proceed to send a unicast OPTIONS message to the remote telephone set 200 periodically, typically once every minute. It will continue to do this until the remote telephone set 200 receives the OPTIONS message and initiates a SUBSCRIBE/NOTIFY message sequence with the local telephone set 200. Upon this successful SUBSCRIBE/NOTIFY event, the local telephone set 200 will NOTIFY all of his peers, whether local or remote, of the remote telephone set 200 network URI address.

Conversely, the local telephone set 200 will also initiate a SUBSCRIBE/NOTIFY message sequence with the remote telephone set 200. Upon this successful SUBSCRIBE/NOTIFY event, this remote telephone set 200 will also NOTIFY all of its known peers, whether local or remote, of the local telephone set 200 network URI address. Any peer telephone set 200 that receives a NOTIFY message, whereby the contents indicate such a “remote discovery” peer network URI address, it can then look at the network URI address and add it to it's internal list if it doesn't have it already. A telephone set 200 that has added a network URI address in this manner would proceed to do the exact same steps as if the network URI address was administratively entered into a telephone set 200, as described above. This propagating behaviour will keep all peer telephone set 200 devices in the system current.

If a telephone set 200 detects that a remote telephone set 200 is no longer available on the network, by using the previously described SUBSCRIBE timeout renewal failure indication, or if the telephone set 200 was newly started, then it will start sending unicast OPTIONS messages to the remote telephone set 200. The local telephone set 200 will know that the remote telephone set 200 is present again once this remote Telephone set 200 acts upon the reception of this OPTIONS message as described above with a SUBSCRIBE/NOTIFY message exchange.

If a telephone set 200 detects that a new telephone set 200 has become available on the network, then upon the previously described SUBSCRIBE timeout renewal it will NOTIFY any new telephone set 200 devices of the remote network URI address of that SUBSCRIBE renewal. That way, the new telephone set 200 can update its list of remote telephone set 200 devices automatically. This is in addition to its local System Discovery where it already discovers the network URI address location of all of its peers on the local LAN network.

This above described auto-NOTIFY method is the preferred method. Another method is for any telephone set 200 to poll request in a NOTIFY for a telephone set 200 to NOTIFY him back of the whole list of remote extensions. The recipient telephone set 200 can than build up and reconcile an extension list from these responses.

One can see that this iterative SUBSCRIBE/NOTIFY mechanism between peer telephone set 200 devices allows each to maintain a current list of remote Telephone Set 200 network URI addresses automatically. The only case where an administrative user intervention is required is if a brand new telephone set 200 device is installed on a new remote LAN segment that doesn't have any existing peer telephone set 200 devices.

It is noted that if the network URI address is a DNS-resolvable domain name, and registered to a SIP proxy service (e.g. joey@sipphone.com), then an existing Telephone Set 200 device can be mobile, i.e. moved to other LAN segments without requiring an administrative update. This telephone set 200 device is reachable, as long as the other telephone set 200 devices in the telephone system 100 are able to initiate SIP communications to that same SIP proxy domain, as is known.

It is noted that this type of wide area discovery can be a concern if one system begins to discover phones that don't belong to that system. Hence, the previously described workgroup mechanism becomes an important consideration. By using the workgroup mechanism, discovery will be limited only to telephone set 200 devices that belong to the same workgroup. Also in this scenario, usage of the authentication and encryption mechanisms becomes important, and are strongly recommended.

It is noted that each telephone set 200 device keeps its own knowledge of the status and configuration data of other telephone set 200 devices in the telephone system 100. There is no dependency on a telephone set 200 device to act as a surrogate or as a backup to another telephone set 200 device that is presently unavailable on the telephone system 100. If an active telephone set 200 device is trying to communicate to an inactive telephone set 200 device, it will know its status and can take appropriate action, since it would know appropriate configuration data such as voicemail delivery, call forwarding options of the unavailable telephone set 200 device. Hence, it could decide to take voicemail, or instigate various call forwarding options on behalf of the unavailable telephone set 200 device.

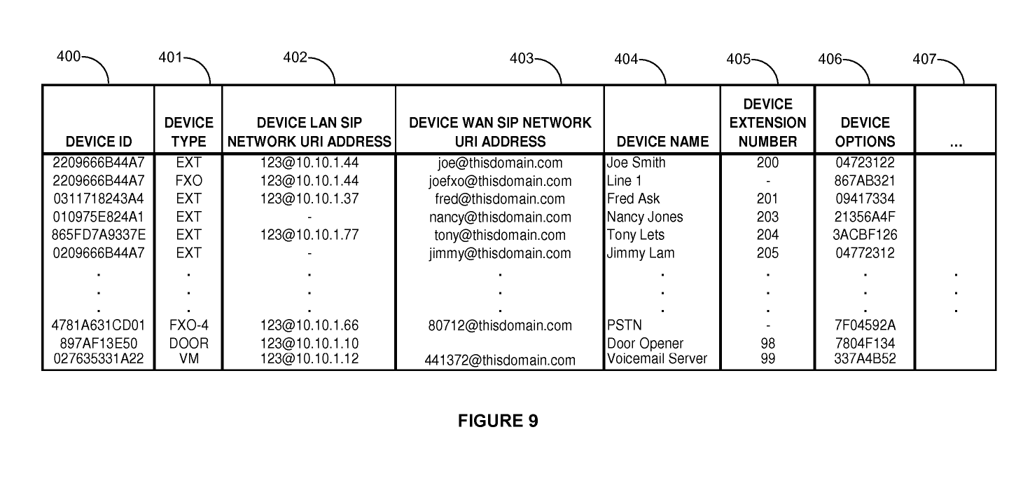

To summarize, FIG. 9 shows in the telephone system 100 a table of data that each telephone set 200 would typically build upon after completing its local and remote discovery processes. This data would typically be maintained in a non-volatile memory medium in the telephone set 200 so that it is preserved between power cycles. In addition to this table, the telephone set 200 would use the previously described local and remote discovery OPTIONS/SUBSCRIBE/NOTIFY procedures to know the state of other telephone set 200 devices (or other like telephone devices) and update the data in this table regarding each of the other telephone set 200 devices.

The preferred method is that the data tabulated in FIG. 9 is built from data exchanged in NOTIFY contents body, preferably encrypted.

The first column in FIG. 9 is DEVICE ID 400. The purpose of this field is to provide a unique identifier to the physical device that was discovered on the LAN/WAN Network 6. This identification value is just required to be any unique value for each device. It could be a unique serial number, randomly generated value, or as is common to one skilled in the art, the MAC address of the device, if it is an Ethernet-associated device. The key point is that this value is the same for the lifetime of the device. The purpose of this field is to provide a unique data identifier in the table for a discovered device. When a discovered device communicates status or configuration data via NOTIFY messages, the DEVICE ID 400 field value is sent so that the recipient device can be certain of which status or configuration data entry needs to be updated.

The second column in FIG. 9 is the DEVICE TYPE 401 field. This field identifies the type of device discovered. Since the telephone system 100 and the system discovery is not limited to discovering just the telephone set 200 device, other types of devices could also be discovered on the LAN/WAN Network 6. Note that more than one table entry can have the same DEVICE ID 400, but with a different DEVICE TYPE 401 field. This is to accommodate devices that may be multifunctional, and effectively have multiple distinct resources in the same physical device. The first 2 entries indicate such a device, such as the telephone set 200, which can act as both a phone extension and provide a single FXO resource. The purpose of this field is to provide a unique resource identifier in the table for a discovered device. When a discovered device communicates status or configuration data via NOTIFY messages, the DEVICE TYPE 401 field value is sent so that the recipient device can be certain of which resource associated with a discovered device needs to be updated.

The third column in FIG. 9 is the DEVICE LAN SIP NETWORK URI ADDRESS 402 field. This field represents the SIP Network URI address for the discovered device on the local broadcast domain of the network. This field may be the same, even for a device that has multiple resources, as described above. In communication to that resource, SIP messages can target the desired resource by unique user parameters on the SIP request line, or by using unique SIP headers, as is known to one skilled in the art. In addition, it is possible that each resource simply has their own unique DEVICE LAN SIP NETWORK URI ADDRESS 402 field value.

In most embodiments of the telephone system 100, the DEVICE LAN SIP NETWORK URI ADDRESS 402 field takes the form of a direct IP address format (e.g. 123@192.168.0.104), where 192.168.0.104 represents the IP address of the originating telephone set 200 device. This is because it is determined automatically from IP address of the originating telephone set 200, and hence no end-user administrative entry is required to determine this local SIP network URI address.

It is noted that if a device had not been discovered on the local broadcast domain network segment, then this entry would always be empty. A device is known to reside on the local network segment when, during the local and remote System Discovery stages described previously, they had initiated the SUBCRIBE/NOTIFY sequence based on the reception of a local network domain broadcast OPTIONS message, as opposed to the reception of a unicast OPTIONS message.

The fourth column in FIG. 9 is the DEVICE WAN SIP NETWORK URI ADDRESS 403 field. This optional field represents the SIP Network URI address for the discovered device on a remote network segment. In addition, it could represent an alternative network URI address that a locally discovered device is reachable at, in addition to the DEVICE LAN SIP NETWORK URI ADDRESS 402 field.

The fifth column in FIG. 9 is the DEVICE NAME 404 field. This optional field would simply represent a friendly name for the resource of the discovered device. For example, in the case of a telephone set 200 extension resource, this could be the user's name, and used in the user interface of the telephone set 200. Similarly, in the case of a telephone set 200 FXO resource, this could be the physical name associated with the FXO line, e.g. “Line 1”.

The sixth column in FIG. 9 is the DEVICE EXTENSION NUMBER 405 field. This field represents the extension number of the telephone set 200 device. Through the system discovery stages all of the extension numbers are then known in the Telephone System 100. As is known, one can easily manage the assignment of these extension numbers at each telephone set 200 using user interface means or other administrative means to set a desired extension number, or even auto assign an extension number. Generally, the extension number of the desired call destination device is dialled on the keypad of the telephone set 200, and an intercom key is pressed to reach the desired device. Normally, these extension numbers are unique for each telephone set 200 device. Generally, as is known, it is easy to detect duplicate entries, and provide a user interface and/or administrative notification to an end user of the duplicate conflict, in order to correct the problem. There are scenarios where having the same extension number is desirable. This generally would be the case where a user dials an extension number, and it can reach more than one telephone set 200, by the use of SIP forking techniques, as is known to one skilled in the art.

The seventh column in FIG. 9 is the DEVICE OPTIONS 406 field. This optional field represents attributes of the resource that may be of interest. This could be a bit-mask entry, or text entry that specifically identifies these attributes. This is just an example of an optional entry, and there would likely be many optional entries that can be envisioned such as an email address, or call forwarding options of an extension resource, or indications if a resource belongs to a defined group, such as a paging zone. An email address can be used by the telephone set 200 device to send informative notifications to the user associated with the discovered telephone set 200 device. This could be a voicemail email if a telephone set 200 device took voicemail on behalf of the discovered telephone set 200 device. Similarly, if a discovered telephone set 200 device was unreachable, the telephone set 200 device could initiate call-forwarding preferences of the discovered telephone set 200 device.

As mentioned previously, a discovered device could have both the DEVICE LAN SIP NETWORK URI ADDRESS 402 field and DEVICE WAN SIP NETWORK URI ADDRESS 403 field entries. This occurs when a device discovered on the local network segment also wishes to communicate that they are available on an alternative network URI address. This would be common, notably when the telephone system 100 is communicating across multiple broadcast domain network segments via the usage of a SIP registrar/proxy server.

In the above SIP registrar/proxy server system operation described above, it requires that each telephone set 200 device have a unique SIP proxy account entry administratively entered into each telephone set 200 device. This is typically a one-time administrative entry or conversely, it could be pre-programmed into each Telephone Set 200 device, either at the factory, or prior to an end-user obtaining the device. When using SIP registrar/proxy servers to facilitate communication across multiple broadcast domain network segments, the DEVICE LAN SIP NETWORK URI ADDRESS 402 field normally cannot be used in SIP messages (specifically the From field) to a remote telephone set 200 device. This is because the message would go through the SIP registrar/proxy server, and the direct IP address format (e.g. 123@192.168.0.104) would generally not be an acceptable SIP URI format for the SIP registrar/proxy server. Hence the originating telephone set 200 device would use its own DEVICE WAN SIP NETWORK URI ADDRESS 403 field entry in the SIP (specifically the From Field) message.

When a local telephone set 200 device calls another local telephone set 200 device, it could use either the DEVICE LAN SIP NETWORK URI ADDRESS 402 or DEVICE WAN SIP NETWORK URI ADDRESS 403 field entries. That is, it can make the call directly across the local LAN segment without the SIP call control messages going through the SIP proxy server, or pass the SIP call control messages pass through the SIP proxy server. Either method is acceptable, but the latter method may be preferred because it can take advantage of services of the SIP proxy server, such as added authentication, security policies, bridging of remote networks, SIP device geographical mobility and value-added network proxy services. Value-added services could be voicemail services, PSTN call services, voice recognition, and others. In this latter method, all call control passes through the SIP proxy server, which is herein called the “SIP proxy mode” of operation.

It is noted, that by having built up distinct knowledge in the telephone set 200 of which other telephone set 200 devices are local or remote, that when operated in “SIP Proxy mode”, that the telephone system 100 can be intelligently operated on the local network segment when the SIP proxy server may have failed, or is temporarily unavailable. That is because the telephone set 200, when trying to reach another telephone set 200 that it knows is also present on the local LAN network segment, can upon knowing that a SIP proxy failure has occurred, make use of the DEVICE LAN SIP NETWORK URI ADDRESS 402 entry instead of the DEVICE WAN SIP NETWORK URI ADDRESS 403 entry. This method of storing both network URI addresses allows a dynamic failover mechanism when normally operating in a “SIP proxy mode”. Once the SIP proxy is operational again, the telephone set 200 can make use again of the DEVICE WAN SIP NETWORK URI ADDRESS 403 entry.

The telephone set 200 can detect that the SIP proxy server may have failed by periodically sending of a proxy-directed OPTIONS message to its own SIP network URI address. (e.g. if telephone set 200 network URI address is joe@thisserver.com, then send an OPTIONS message to joe@thisserver.com directed through the SIP proxy server). This message would go to the SIP proxy server, and then be received by the same sending telephone set 200 device. If it is not received within a desired timeout window, then the telephone set 200 can make the determination that the SIP proxy server has failed. This timeout window is normally about 32 seconds in many SIP implementations, but it can be set much shorter. Notably, if a SIP proxy server is taking up to 32 seconds to respond, it is likely overloaded, and may be impaired in its operation. Hence a shorter timeout window can be used if one wants to determine that a SIP proxy server is failing not only because of no OPTIONS message response, but also in the scenario of a slow OPTIONS message response.

Conversely, when a SIP proxy failure has occurred, the telephone set 200 can still send periodic OPTIONS message. Once a response is received from the SIP proxy server, then it knows that the SIP proxy server is operational again.

It is known that sending other SIP messages such as an INVITE or REGISTER message can make a similar determination when they do not receive a corresponding response from the SIP proxy server.

It is noted that with the “SIP proxy mode” of operation, the SIP registrar/proxy server typically provides for bridging remote network segments, and allow the Telephone Set 200 to navigate through most firewalls, NATs and other common network devices, allowing communication to other telephone set 200 devices, in addition to other network based SIP services. At its simplest level, the SIP registrar/proxy server provides delivery of the various OPTIONS, INVITE, SUBSCRIBE, NOTIFY, etc . . . messages to other telephone set 200 devices.

The operation of the SIP registrar/proxy server, and assignment of DEVICE WAN SIP NETWORK URI ADDRESS 403 values are not always under the control of the end user, but are typically assigned by the operators of the SIP proxy service (unless an end user deploys their own SIP proxy server, and they are appropriately technically adept). Many SIP registrar/proxy servers are run as commercial offerings, and can optionally offer other advanced network SIP services, such as network voicemail services, network PSTN termination services, and others. Such an example would the SIP proxy server networks such as SipPhone, Vonage, and others.

It is common to these SIP proxy servers, at least those that obey typical SIP proxy server functions, that telephone system 100 can run, effectively as a peer-to-peer operational overlay, on a SIP proxy server. Hence the telephone system 100 can still perform its advanced call operations such as voicemail, call transfers, call forwarding, call conferences, multiple call handling, end user assignment of office extension numbers, sharing of FXO resources on both local and remote sites, and others.

The preceding is possible without any administrative setup from the operators of the SIP proxy server, other than administratively entering into each telephone set 200, the unique SIP proxy account information as previously described. That is, the coordination and delivery of these advanced call operations is under the control of each telephone set 200, with no central server coordinating the operation and delivery of these features. Notably, the SIP proxy server allows this office phone system operation to be easily operated in a multi-site and distributed fashion.

This is a very powerful capability for it allows delivering a common office phone system operation capability onto a SIP proxy service that did not natively have this capability. In addition, the control, and management of the office phone system operation is under control of the end user, not the operators of the SIP proxy server. If an end user uses a commercial SIP proxy server, they also do not need to invest in the capital expenditure and maintenance of a SIP proxy server. For an end user that wants a multi-site operation of the telephone system 100, this may be an attractive option rather than deploying a corporate VPN network setup.

This method extends to beyond fixed location Telephone Set 200 devices, but also to other SIP device endpoints that embed the peer-to-peer technology. Such devices could be WiFI handsets, WiFi enabled cellphones, PDAs, PCs, and others. With the peer-to-peer technology embedded in these devices, they can also participate in the telephone system 100.

With the previously described authentication and encryption methods, it allows these advanced call operations to be delivered to just like-telephone set 200 and similar devices that belong to the same workgroup. This provides additional authentication and security mechanisms that may not natively be provided by the SIP proxy server.

In the telephone system 100, a telephone set 200 require the capability of performing a technique called SIP INVITE parallel forking, referred subsequently herein as forking. This is a feature commonly available from a TCP/IP protocol telephone system with a centrally control server. Within this central server, this forking capability is provided by what is called a proxy server software component. However, since a centrally control server is not part of the system, the telephone set 200 devices themselves require this capability. Forking is a key requirement to handle typical multi-line phone system scenarios. SIP INVITE messages are the foundation for establishing a VoIP communication session with another device. Recipient devices will either accept (SIP OK response) or reject (SIP non-OK response) the INVITE. If a device wants to, it can INVITE multiple devices to a session at the same time. This is forking, and the device typically accepts the first device that responds with an OK response and cancel (SIP CANCEL and/or BYE messages) to any of the other responding devices.

For illustrative purposes, the following is a description of one instance where forking is required. When a telephone set 200 device receives an incoming call on its FXO port, it will generally want to alert (ring), all other telephone set 200 devices in the system. It does this by forking (sending SIP INVITE message) to all the telephone set 200 devices. The telephone set 200 handles the forking process, and will route the FXO voice call to the first telephone set 200 device that responds with an OK response. By default, all of the telephone set 200 devices in the system would be forked to, but it could be a subset of this, depending on various user-defined parameters such as caller-id information, time/date, and telephone set states.

Another illustrative example of where forking is required is for when an external SIP call originates from the WAN. The WAN device that originated the call generally may not know the specific IP address of a telephone set 200 because of NAT/Firewall (router) issues. The incoming SIP call would be “port forwarded” by the router to a telephone set 200 that is designated to act as recipient for external WAN SIP calls. When the designated telephone set 200 device receives an incoming SIP call on its LAN Interface 15, it will resolve the SIP URI to determine the actual intended telephone set 200 device(s). It will generally want to alert (ring), all other telephone set 200 devices in the system. It does this by forking (sending SIP INVITE message) to all (or a subset of) the telephone set 200devices. The designated telephone set 200 handles the forking process, and will route the WAN SIP call to the first telephone set 200 device that responds with an OK response. This forking process is familiar to one skilled in the art.

Each telephone set 200 device in the system needs to share and maintain appropriate common system data current amongst all of the telephone set 200 devices. In the subject system, the devices would co-operatively share this information amongst themselves by sending/receiving messages across the LAN/WAN Network 6. Many methods to do this are familiar to one skilled in the art. Naturally one needs to take necessary steps to ensure the validity and integrity of this shared data.

It should be noted that the telephone system 100 provides nonblocking operation of intercom calls between telephone set 200 devices. This means that any telephone set 200, at any time, can perform an intercom call to any other Telephone Set 200. This is a strong advantage over prior art RF-based telephone system implementations, whereby the number of simultaneous intercom calls across the common communications channel in the overall telephone system was limited by the RF-channel capacity of the telephone system.

Telephone System 100 Voice Messaging Capabilities

Beyond the advanced messaging capabilities of the telephone set 200, the telephone system 100 also has a method with respect to providing advanced system-wide voice messaging capabilities with a multitude of telephone set 200 devices. Due to the many deficiencies and limitations of the prior art, commercial voice-message implementations have been shown to be dismal in providing capable business-quality telephone system voice messaging services.

The following method provides common business-quality voice messaging services, with the “plug and play” functionality of the system. These methods relate to common voicemail/auto-attendant related features. Specifically, these are audio greetings, and “dial-by-name” feature. The methods relate to how these features are coordinated and delivered amongst a multitude of telephone set 200 devices. This does not preclude the Telephone System 100 operating with a conventional centralized voicemail/auto-attendant device or service.

A method of advanced voice messaging capabilities of the telephone system 200 is the appropriate sharing of audio greeting and operational configuration files between telephone set 200 devices. At a minimum, a typical voicemail/auto-attendant function requires audio greeting files such as welcome greetings, common system messages and individual user greetings. Configuration files would include such common functional information as time/date operating modes, number of rings before answering calls, caller-id matching settings and the like, to permit this type of configuration information.

As previously described, each telephone set 200 knows details about other telephone set 200 devices in the network. Each device stores the network addresses, names, associated user names, intercom numbers and various capabilities of the others. Using this information, each device can retrieve individual user greetings, and the associated user data, and store this data locally on each the telephone set 200. By doing this, each telephone set 200 has the minimal capabilities to handle voicemail/auto-attendant capabilities servicing calls terminated on this device from the FXO port(s), or from the LAN/WAN network.

As an illustrative example, when each user sets up a telephone set 200, the user will be prompted to record a user greeting and the user could also record the main system greeting. This user greeting would be stored locally on the telephone set 200. In addition, the users are prompted to enter their full name (e.g. Bob Smith). Conversely, these greetings and information could be retrieved from a centralized configuration server.

Once a telephone set 200 is initialized, and in the Device Ready state (as described previously), the telephone set 200, can proceed to retrieve the user greetings and user information from the other telephone set 200 devices in the system. Various protocols of transferring this information across the LAN Interfaces 15 can be used, such as TFTP, FTP, HTTP, SIP/RTP and SCP. The welcome greeting would be administered especially so that it can negotiate which greeting to use amongst the system. Methods would include allowing only one welcome greeting to be recorded in the system, using only the welcome greeting with the latest recording date, or retrieving the welcome greeting from a centralized configuration server.

Once the telephone set 200 has collected all the necessary greetings and information, it is trivial to allow the device to competently perform voicemail/auto-attendant functions. The telephone set 200 can handle voicemail/auto-attendant functions for calls received on the attached FXO Circuit 10, or via the LAN/WAN Network 6. Having the information resident in each telephone set 200 allows the telephone system 100 to independently handle voicemail/auto-attendant functions even if another user's telephone set 200 is then off-line for any reason. This provides robust and reliable (non-centralized) system operation.

The recorded voicemail message could be handled by any of telephone set 200 devices in telephone system 100. Various methods of delivering the recorded voicemail message to the intended recipient(s) are possible. For illustrative purposes, the voicemail messages can be sent to the recipient via e-mail methods (e-mail method), where the recipient can receive the message in an assigned e-mail inbox. Alternatively (or in addition), the voice mail message can be transferred directly (transfer method) to the intended recipient's actual telephone set 200. This transfer could use various LAN protocols such as TFTP, FTP, HTTP, SIP/RTP and SCP. The recipient could listen to the voicemail message on the recipient's telephone set 200 in the usual manner. The e-mail method is attractive, especially if the telephone set 200 has limited amounts of memory storage.

A combination of the e-mail and transfer methods is attractive. The following is an illustrative example. If the transfer method is used, the user can manipulate the voicemail on the telephone set 200 in the usual manner, such as navigating through key and LCD display prompts and listen using the telephone set 200 handset or speaker. At this time the user can listen to the message, delete it, or have the option of forwarding the message to the user's (or other) e-mail addresses. An administrative setting in the telephone set 200 could also automatically e-mail the message to pre-determined addresses under various scenarios. These could include scenarios such as if the local storage is full, or based upon time/date/holiday and caller identification settings and some simple (or complex) rules.

The e-mail addresses of possible recipients can be known by various methods. One method is when a user can enter in a telephone set 200 by administrative methods that uses actual name and user e-mail address. This information is then shared with other telephone set 200 devices in the telephone system 100. Alternatively, the telephone set 200 can interact with a central user information server, such as a LDAP server. For example, for one skilled in LDAP servers, one can retrieve information such as e-mail address associated with a user.

The voice messaging capabilities of telephone system 100 are significant, for they can deliver advanced capabilities using only one or more telephone set 200 devices. This provides significant cost and complexity advantages for the end customers who want advanced voice messaging capabilities.

### Additional Embodiments

An additional embodiment of telephone system 100 as represented in FIG. 1, is that each telephone set 200 does not necessarily need to have a telephone line connected to its FXO Circuit 10. In this embodiment, the telephone system 100 still works normally and when the specific telephone set 200 capabilities are discovered by the System Discovery process, it can simply indicate that there is no FXO port resource available.

This notion leads to additional embodiments of telephone set 200. Additional embodiments of telephone set 200 could have no FXO circuit, but it could also have multiple FXO circuits. Again, when the capabilities are discovered by the System Discovery process, it would make this resource information known to the telephone system 100.

An additional embodiment of telephone set 200 is one that uses different physical LAN interfaces such as wireless interfaces (802.11) or different wired interfaces such as emerging higher speed LAN interfaces or optical LAN interfaces.

An additional embodiment of telephone set 200 is one that is created solely as a softphone, running on a PC or a handheld device.

These additional embodiments of Telephone Set 200 would have appropriate software to participate in the telephone system 100.

An additional embodiment of telephone system 100 is one that uses alternative LAN protocols. To one skilled in the art, many alternative or new LAN protocols could be used to implement the telephone system 100.

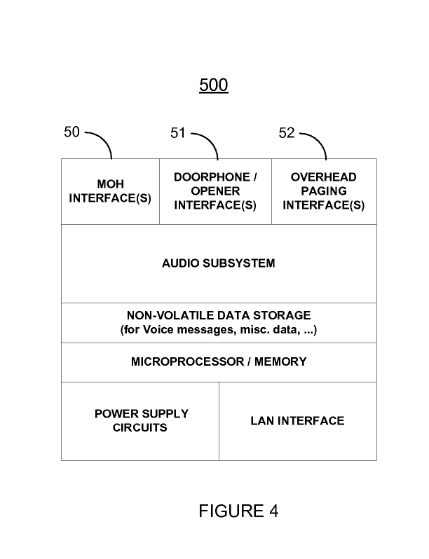

With the server-less and “plug and play” functionality of the telephone system 100 there are many alternative embodiments of this invention. FIG. 4 shows an example of an alternative embodiment. In this telephone system 700, any combination of Feature Device or Service 5-1 through to 5-N would be part of the telephone system. Telephone set 2-1 through 2-N are shown without analog telephone lines connected, but this does not need to be the case. Telephone set 2-1 through 2-N are optional in telephone system 700, for call devices could be provided from other means such as PCs, cordless or wireless handset devices.

An illustrative functional block diagram of an optional feature device is a Voice Messaging 500 device, as shown in FIG. 4. It is a device that could provide centralized voicemail, auto-attendant, IMAP4 unified voice mail server, music-on-hold (MOH), overhead paging, door opener and door phone functionality familiar to one skilled in the art. In addition to previously described components, it comprises of the following: a non-volatile data storage area 54 (for storage of configuration information, and voicemail and greeting messages); the MOH Interface(s) 50, Doorphone/Opener Interface(s) 51 and Overhead Paging Interface(s) 52 are familiar to one skilled in the art.

This alternative embodiment opens the concept that some of the advanced voice messaging capabilities resident in the telephone set 200 or telephone system 100 can be partially or completely provided by the Voice Messaging 500 device. For example, having voicemail in a separate device can provide more cost effective mass storage of messages. In addition, this is a convenient device to provide the MOH, overhead paging and door opener/phone functionality. Voice messaging storage and access could also be provided as a third-party service available over the Internet.

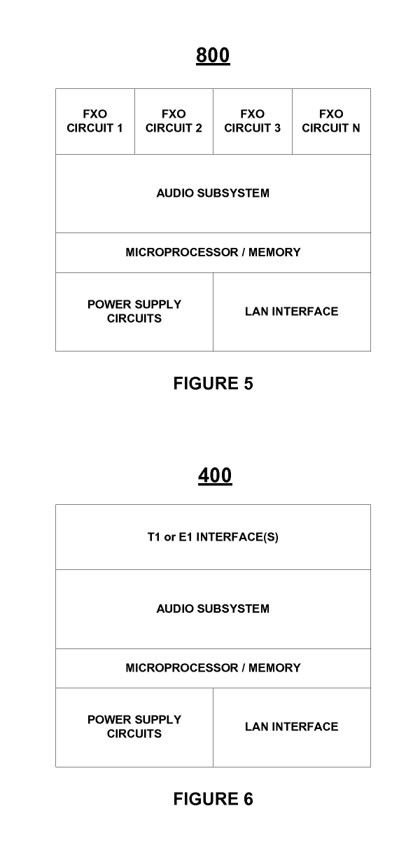

Other illustrative functional block diagrams of other optional feature devices are a Multi-Port FXO 800 device and a T1/E1 Access 400 device, as shown in FIGS. 5 and 6 respectively. These feature devices would provide additional PSTN access methods for the telephone system. The Multi-Port FXO 800 device can alleviate the need to route an analog telephone line to a telephone set 200. This simplifies wiring in the office. The T1/E1 Access 400 device would allow the telephone system 100 to expand greatly the PSTN access capabilities of the system. This is in contrast to prior art for a telephone system without central control, which was limited to accessing only FXO ports. As previously described for telephone set 200, whereby it performs forking upon reception of an incoming FXO call, these devices would perform the forking of incoming PSTN calls as is appropriate for the telephone system. The use of these devices may also be characterized as delivery of additional voice processing services over the system.

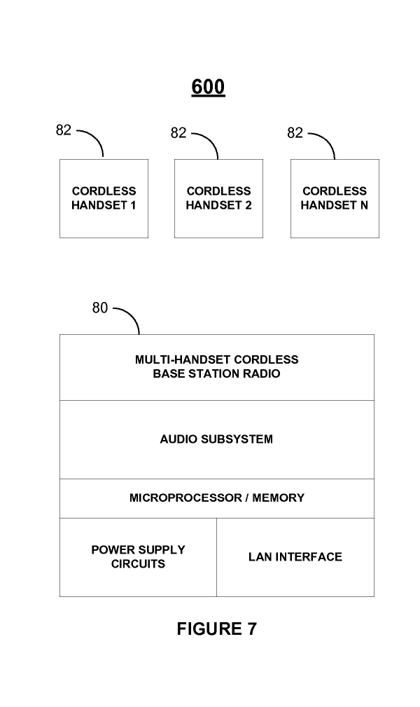

An illustrative functional block diagram of another feature device is a Multi-Handset Cordless Base Station device 600, as shown in FIG. 7. The Multi-Handset Cordless Base Station Radio 80 handles the Cordless Handsets 82, as is known in the art. A multitude of Multi-Handset Cordless Base Station devices 600 could be present in the system, and coordinate handset roaming/handoff activities between each other by signalling appropriately over the LAN/WAN Network 6. The advantage of a device like this is to add cordless phone capabilities to the telephone system 700. This can also be accomplished by having handset devices that operate directly on well-known 802.11 or Wi-Fi wireless technologies.

An illustrative example of another feature device would be a common office router that is enhanced with SIP proxy and registrar services. This could handle more gracefully the handling of incoming SIP calls originating from the WAN, without resorting to port forwarding. Devices in telephone system 700 can register with this device, as usual, and then this device can handle the appropriate routing of incoming WAN SIP calls.

It is also possible to create a complex feature device that combines multiple features such as voice mail, autoattendant and PSTN access, or other functions as an optional device, and the operation of the telephone system 700 would not be wholly dependent on its presence. Some telephone system features may be missing, and basic functionality of telephone sets would be required.

There is also the concept of a Feature Service, such is commonly found out in the WAN environment (i.e. Internet). These services may not be able to be discovered automatically, but their location would be entered into any appropriate device by administrative methods known in the art. Example of such feature services could include WAN PSTN calling services (DeltaThree, Net2Phone, and others), voice recognition services, centralized voice mail storage and retrieval services, and call conference services.

Again, it is possible that a Feature Device or Service 5-1 through to 5-N, such as the illustrative examples above, can go through similar system discovery methods described previously, and are not controlled by a central server, but are provided using the systems and methods of this invention.

### Conclusion

In the basic embodiment of the telephone system 100, a full-featured phone system is created using solely one or more telephone set 200 devices. In the basic telephone system 100, multi-line PSTN and VoIP calls can be handled, and advanced voice messaging capabilities can be provided. There is no central control point in the telephone system 100. This system concept provides advantages to end users in being able to affordably scale down to offices as small as one user, and improves system reliability because there is no central point of failure.

It is apparent that the embodiments described herein may be varied to meet particular specialized requirements of the particular requirements or deployment of the system as understood to those skilled in the art.

1. A method for a first telephony network device to discover and communicate with a second telephony network device across a wide area network for establishing an operative communication link between the first and second telephony network devices and between at least one local peer of either the first or second telephony network device comprising the steps of:
a) the first telephony network device sending out a unicast discovery message to a predetermined device network address associated with the second telephony network device;
b) the second telephony network device receiving and responding to the unicast discovery message with a discovery response message;
c) the first and second telephony network devices establishing an operative communication link between each other; and
d) wherein upon establishment of an operative communication link between the first and second telephony network devices, either or both of the first and second telephony network devices enabling operative wide area and local area communication between the first and second telephony network devices and the at least one local peer.

2. A method as in claim 1 wherein each of the first and second telephony network devices have at least one local peer.

3. A method as in claim 1 wherein each of the first and second telephony network devices each have both a local area network address and a wide area network address and wherein both the local area and wide area network addresses are simultaneously allowed to enable operative communication between local area peers utilizing either of the local area or wide area network addresses.

4. A method as in claim 2 wherein the local area network includes a plurality of local peers and wherein the local peers self-organize upon addition of each successive local peer to the local area network.

5. A method as in claim 1 wherein steps a) and b) are periodically repeated to monitor dynamic changes in the network.

6. A method as in claim 1 wherein the first telephony network device discovers peer network devices on a local area network comprising the steps of:
a) the first telephony network device sending out a broadcast discovery message;
b) at least one peer network device receiving and responding to the broadcast discovery message with a discovery response message;
c) the first telephony network device and at least one peer network device establishing an operative communication link between each other; and
d) wherein upon establishment of an operative communication link between the first telephony network device and at least one peer network device, enabling operative wide area and local area communication between the first and second telephony network devices and the at least one local peer.

7. A method as in claim 1 wherein the predetermined device network address associated with the second telephony network device is manually entered into the first telephony network device.

8. A method as in claim 1 wherein the second telephony network device is a mobile telephony device and the wide area network includes an operative proxy service to enable movement of the mobile telephony device to an alternate local area network segment without administrative update.

9. A method as in claim 1 wherein operative communication between the first and second telephony network devices is enabled if both the first and second telephony network devices are within the same defined workgroup.

10. A method as in claim 1 further comprising the step of establishing a telephone call between the first and second telephony network devices using any one of a local area device network address or a wide area device network address.

11. A method as in claim 1 wherein the wide area network includes a proxy server.

12. A method as in claim 1 wherein the second telephony network device is any one of a WiFi handset, WiFi enabled cellphone, personal data assistant (PDA) or personal computer.

13. A method as in claim 1 further comprising the step of inviting multiple network devices to a communication session at the same time by forking.

14. A method as in claim 1 further comprising the steps of initializing the first telephony network device with voice mail information; sharing the first telephony network device voice mail information with the second telephony network device; retrieving similar voice mail information from the second telephony network at the at least one peer; and enabling local area network and wide area network voice mail functionality.

15. A method as in claim 14 further comprising the step of forwarding a recorded voice mail message to a user's email address.

16. A method for a first telephony network device to discover and communicate with other peer network devices across a local area network for establishing an operative communication link between the first telephony network device and at least one peer network device within a defined workgroup comprising the steps of:
a) the first telephony network device sending out a broadcast message to a local area network to identify all peer network devices on the local area network; and,
b) automatically establishing an operative communication link with all identified peer network devices on the local area network within the defined workgroup.

17. A method as in claim 16 wherein upon establishment of an operative communication link between all identified telephony network devices on the local area network within the defined workgroup, automatically enabling operative wide area and local area communication between all telephony network devices across a wide area network within the defined workgroup.

18. A method as in claim 16 wherein the defined workgroup is a hash of a defined workgroup name and wherein an operative communication link between the first telephony network device and at least one peer network device is established only if both the first telephony network device and at least one peer network device have the same hash.

19. A method as in claim 16 wherein the workgroup name is manually entered into each of the first telephony network device at the other peer network devices.

20. A method as in claim 16 wherein a telephony network device is authorized to establish operative communication links within two or more defined workgroups.

21. A method for at least two local telephony network devices defined as local peers to communicate with each other across both a wide area network and a local area network comprising the steps of:
a) simultaneously enabling a local area network address and a wide area network address on each of the local telephony network devices; and,
b) enabling operative communication between local area peers utilizing either of the local area or wide area network addresses.

22. A method as in claim 21 wherein, following a failure of the wide area network while operative communication of two local area peers utilizing their respective wide area network addresses is enabled, automatically switching to use of local area network addresses to maintain operative communication between the local area peers.

23. A method as in claim 21 wherein the wide area network includes a proxy server and wherein failure of the proxy server during operative communication of two local area peers utilizing their respective wide area network addresses, automatically switching to use of local area network addresses to maintain operative communication between the local area peers.

24. A network device enabled to discover and communicate with a second network device across a wide area network for establishing an operative communication link between the network device and the second network device and between at least one local peer of the network device comprising:
a microprocessor operatively connected to a wide area network communication interface, the microprocessor for a) sending out a unicast discovery message to a predetermined device network address associated with the second network device; b) receiving and responding to a discovery response message from the second network device; c) establishing an operative communication link between the network device and the second network device; and d) whereupon establishment of an operative communication link between the network device and second network device, enabling operative wide area and local area communication between the each of the network device, the second network device and the at least one local peer.

25. A network device as in claim 24 wherein the network device includes memory operatively connected to the microprocessor for maintaining a table of data having data fields relating to the establishment and maintenance of the communication link and the second network device.

26. A network device as in claim 24 wherein the data fields include a device ID field.

27. A network device as in claim 24 wherein the data fields include a device type field.

28. A network device as in claim 24 wherein the data fields include a local area network network address field.

29. A network device as in claim 24 wherein the data fields include a wide area network network address field.

30. A network device as in claim 24 wherein the data field include a device name field.

31. A network device as in claim 24 wherein the data fields include a device extension number field.

32. A network device as in claim 24 wherein the data fields includes at least one device options field.

33. A network device as in claim 32 wherein the device options field includes fields corresponding to any one of or a combination of an email address, call forwarding options or workgroup name.

34. A system comprising:
at least two local network devices within a local area network;
at least one remote network device outside the local area network but operatively linked to the local area network,
wherein each local network device is enabled to allow the local and remote devices to discover and communicate within the local area and wide area networks, each local network device comprising
a microprocessor operatively connected to a wide area network communication interface, the microprocessor for a) sending out a unicast discovery message to a predetermined device network address associated with at least one remote network device; b) receiving and responding to a discovery response message from the at least one remote network device; c) establishing an operative communication link between the local area network device and the at least one remote network device; and d) whereupon establishment of an operative communication link between the local area network device and at least one remote network device, enabling operative wide area and local area communication between the each of the local area network devices and the at least one remote network device.

35. A telephone system as in claim 34 wherein the local network devices and at least one remote network device are selected from any operative combination of a centralized voice messaging device, an auto-attendant, unified voice mail server, music-on-hold device, overhead paging device, door opener or door phone.
